(19) United States
(12) Patent Application Publication
(10) Pub. No.: US 2011/0287128 A1
(43) Pub. Date: Nov. 24, 2011

(54) INJECTION MOLD

(75) Inventor: CHIEN-FENG HUANG, Tu-Cheng (TW)

(73) Assignee: HON HAI PRECISION INDUSTRY CO., LTD., Tu-Cheng (TW)

(21) Appl. No.: 12/871,925

(22) Filed: Aug. 31, 2010

(30) Foreign Application Priority Data
May 20, 2010 (TW) 99116025

(51) Int. Cl. B29C 45/73

(52) U.S. Cl. 425/547

(57) ABSTRACT

An injection mold includes a mold body and an open-loop water channel. The mold body includes a molding surface and a number of side surfaces surrounding the molding surface, and a number of mold cavities defined in the molding surface. The water channel is defined in the mold body. An open end of the open-loop water channel serves as an inlet. The other open end of the open-loop water channel serves as an outlet. The inlet is configured for introducing water into the water channel. The outlet is configured for draining the water out of the water channel. Each of the inlet and the outlet extends through two different side surfaces. In addition, the inlet and the outlet are separated from each other by a base material of the mold body.

### BACKGROUND

1. Technical Field

The disclosure generally relates to injection molds and, particularly, to an injection mold with a water channel.

2. Description of Related Art

The typical methods of cooling an injection mold is to pass a coolant, such as water, through a series of channels defined in a mold plate and connect hoses to form a continuous pathway. The coolant absorbs heat from the mold plate (which has absorbed heat from the hot plastic) and keeps the mold plate at a proper temperature to solidify the plastic at the most efficient rate. FIG. 3 shows a typical injection mold 10A with a water channel 5. The injection mold 10A has an inlet 3 and an outlet 7 defined at two sides thereof. The inlet 3 is configured for introducing water into the water channel 5. The outlet 7 is configured for draining the water out of the water channel 5. However, as the water channel 5 is designed to have a closed loop distribution, the water II introduced into the inlet 3 interferes with the water IV to be drained out of the outlet 7. The water thus cannot flow fluently in the water channel 5 to absorb heat. The injection mold 10A may be overheated.

Therefore, what is needed, is an injection mold with a water channel, which can overcome the above shortcomings.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a perspective view of an injection mold in accordance with an exemplary embodiment.

FIG. 2 is a sectional view of the injection mold of FIG. 1, taken along line II-II.

FIG. 3 is a schematic view of a typical injection mold with a closed-loop water channel.

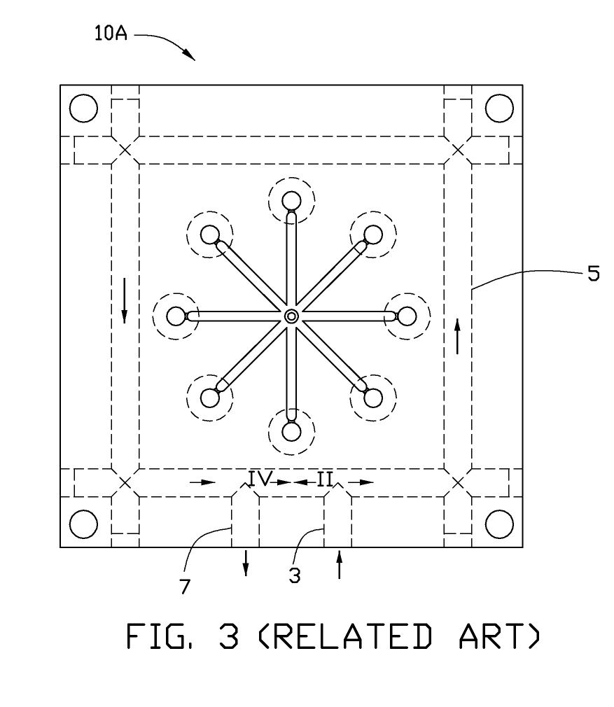

### DETAILED DESCRIPTION

Embodiment of the injection mold will now be described in detail below and with reference to the drawings.

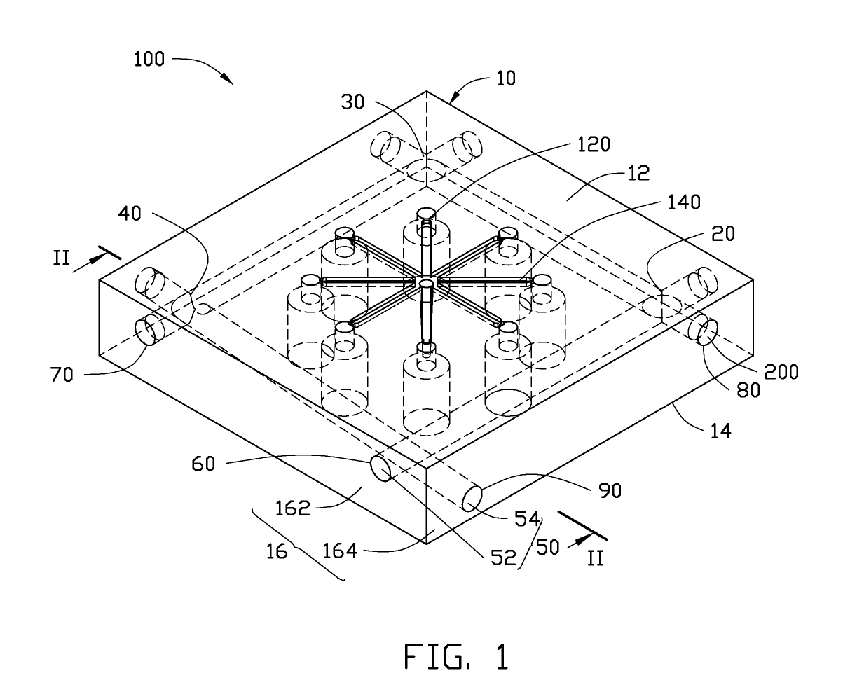

Referring to FIG. 1, an injection mold 100 in accordance with an exemplary embodiment is shown. The injection mold 100 includes a mold body 10 and a water channel 50 defined in the mold body 10.

In this embodiment, the mold body 10 is substantially cuboid-shaped. A base material of the mold body 10 is stainless steel. The mold body 10 includes a molding surface 12, a bottom surface 14, and a side surface 16. The molding surface 12 and the bottom surface 14 are located at opposite sides of the mold body 10, and the molding surface 12 and the bottom surface 14 are substantially parallel to each other. The side surface 16 is located between and adjoins the molding surface 12 and the bottom surface 14. The side surface 16 includes two substantially parallel first surfaces 162, and two substantially parallel second surfaces 164. Each of the second surfaces 164 are located between and adjoin the two first surfaces 162. The mold body 10 has a number of mold cavities 120 defined in the molding surface 12. The mold cavities 120 are configured for molding a number of workpieces, such as lenses or lens barrels. In addition, the mold body 10 has a number of runners 140 defined in the central portion of the molding surface 12. The runners 140 are configured for introducing molding material, such as plastic into the mold cavities 120. In this embodiment, each of the mold cavities 120 extends all the way through the bottom surface 14. The runners 140 are surrounded by the mold cavities 120, and communicate with the respective mold cavities 120.

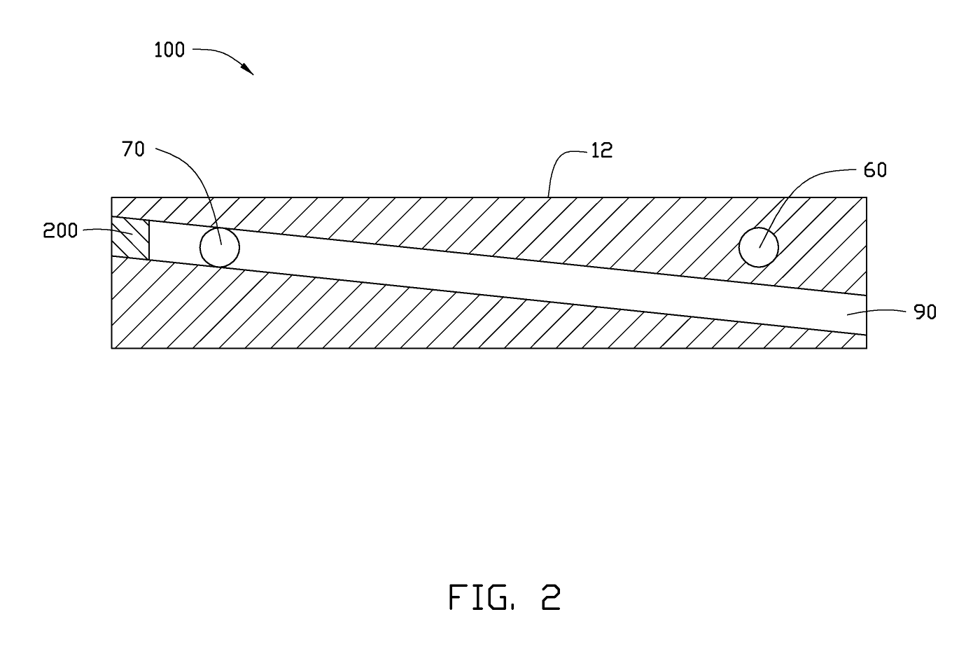

The water channel 50 has an open-loop distribution. That is, the water channel 50 has two separate distal ends, and the water channel 50 extends from one distal end to the other distal end. In this embodiment, the mold body 10 has a first straight channel segment 60, a second straight channel segment 70, a third straight channel segment 80, and a fourth straight channel segment 90 defined therein. Each of the first and the second straight channel segments 60 and 70 extends through the two first surfaces 162. Each of the third and the fourth straight channel segments 80 and 90 extend through the two second surfaces 164. In this embodiment, each of the first, the second, the third, and the fourth straight channel segments 60, 70, 80, and 90 are cylindrical. The first and the second straight channel segments 60 and 70 are located adjacent to the two respective second surfaces 164. The third and the fourth straight channel segments 80 and 90 are located adjacent to the two respective first surfaces 162. The first and the second straight channel segments 60 and 70 are substantially parallel to each other. The third and the fourth straight channel segments 80 and 90 are substantially parallel to each other, and are substantially parallel to the respective second surfaces 164. The third straight channel segment 80 connects the first straight channel segment 60 to the second straight channel segment 70. In this embodiment, the third straight channel segment 80 intersects with the first straight channel segment 60, and cooperates with the first straight channel segment 60 to form a first intersection 20. In addition, the third straight channel segment 80 intersects with the second straight channel segment 70, and cooperates with the second straight channel segment 70 to form a second intersection 30. The fourth straight channel segment 90 is connected to the second straight channel segment 70 but is separated from the first straight channel segment 60 by the base material of the mold body 10. In this embodiment, the fourth straight channel segment 90 intersects with the second straight channel segment 70, and cooperates with the second straight channel segment 70 to form a third intersection 40. Each of the first, the second, and the third straight channel segments 60, 70, and 80 are substantially parallel to the molding surface 12. In this embodiment, as shown in FIG. 2, the fourth straight channel segment 90 is inclined relative to the molding surface 12.

The injection mold 100 further includes six curb stops 200. The curb stops 200 interfere and are received in the respective ends of the first, the second, the third, and the fourth straight channel segments 60, 70, 80, and 90, which are located adjacent to the corresponding first, second, and third intersections 20, 30, and 40. The six curb stops 200 and the first, the second, the third, and the fourth straight channel segments 60, 70, 80, and 90 cooperatively form the water channel 50.

In this embodiment, an open end of the water channel 50 is exposed at the first surface 162 (also is an end of the first straight channel segment 60 distant from the first intersection 20) serves as an inlet 52 of the water channel 50. The other open end of the water channel 50 exposed at the second surface 164 (also is an end of the fourth straight channel segment 90 distant from the third intersection 40) serves as an outlet 54 of the water channel 50. The base material of the mold body 10 separates the inlet 52 and the outlet 54 from each other. The inlet 52 and the outlet 54 are located adjacent to an intersection of two neighboring first surface 162 and second surface 164.

In use, the inlet 52 is configured for introducing cooling water into the water channel 50. The outlet 54 is configured for draining the water out of the water channel 50.

One advantage of the injection mold 100 is that the injection mold 100 is equipped with an open-loop water channel 50. The inlet 52 and the outlet 54 are separated by the base material of the mold body 10, thus interference of the water introduced into the inlet 52 and the water to be drained out of the outlet 54 is avoided. The cooling water can flow fluently through the water channel 50 to cool the mold body 10 during operation of the injection mold 100. In this manner, the water absorbs heat from the mold body 10 and keeps the mold body 10 at a proper temperature to solidify the plastic at the most efficient rate.

It is understood that the above-described embodiment are intended to illustrate rather than limit the disclosure. Variations may be made to the embodiment without departing from the spirit of the disclosure. Accordingly, it is appropriate that the appended claims be construed broadly and in a manner consistent with the scope of the disclosure.

What is claimed is:

1. An injection mold comprising:
a mold body comprising a molding surface and a plurality of side surfaces surrounding the molding surface, and a plurality of mold cavities defined in the molding surface;
an open-loop water channel defined in the mold body, the water channel comprising an inlet for introducing water into the water channel and an outlet for draining the water out of the water channel, the inlet and the outlet respectively exposed at two different side surfaces.

2. The injection mold of claim 1, wherein the mold body is cuboid-shaped, the side surfaces comprises two parallel first surfaces and two parallel second surfaces, each of the second surfaces is located between and adjoins the first surfaces, the inlet and the outlet are adjacent an intersection of two neighboring first and second surfaces.

3. The injection mold of claim 2, wherein the water channel comprises a first straight channel segment with the inlet, a second straight channel segment, a third straight channel segment, and a fourth straight channel segment with the outlet, the first straight channel segment and the second straight channel segment are parallel to each other, the third straight channel segment connects the first straight channel segment to the second straight channel segment, the fourth straight channel segment is connected to the second straight channel segment and separated from the first straight channel segment, the first straight channel segment and the second straight channel segment are located adjacent to the respective second surfaces, the third straight channel segment and the fourth straight channel segment are located adjacent to the respective first surfaces.

4. The injection mold of claim 3, wherein the first straight channel segment and the second straight channel segment are parallel to the respective second surfaces, the third straight channel segment and the fourth straight channel segment are parallel to the respective first surfaces.

5. The injection mold of claim 3, wherein each of the first straight channel segment, the second straight channel segment, and the third straight channel segment is parallel to the molding surface, and the fourth straight channel segment is inclined relative to the molding surface.

6. The injection mold of claim 1, wherein the mold body includes a bottom surface at an opposite side thereof to the molding surface, and each of the mold cavities extends from the bottom surface to the molding surface.

7. The injection mold of claim 1, wherein the mold body has a plurality of runners defined in a central portion of the molding surface, the runners are surrounded by the mold cavities, and the runners communicate with the respective mold cavities.

8. An injection mold comprising:
a mold body comprising a plurality of molding cavities defined therein and a plurality of side surfaces surrounding the molding cavities; and
an open-loop water channel defined in the mold body, the water channel surrounding the molding cavities therein, and comprising a plurality of straight channel segments, the channel segments including an input channel segment for introducing water into the water cooling channel and an output channel segment for draining the water out of the water cooling channel, the input and output channel segments extending along two disjoint and nonparallel lines and exposed at two different adjacent side surfaces.

9. The injection mold of claim 8, wherein the input and output channel segments are substantially perpendicular to each other.
